(19) United States
(12) Patent Application Publication
(10) Pub. No.: US 2004/0039822 A1
(43) Pub. Date: Feb. 26, 2004

(54) Process for managing context data using an intermediate server

(76) Inventor: Michael Bensimon, Grenoble (FR)

Correspondence Address: PERMAN & GREEN, 425 POST ROAD, FAIRFIELD, CT, 06824, US

(21) Appl. No.: 10/465,678

(22) Filed: Jun. 19, 2003

(30) Foreign Application Priority Data
Jun. 20, 2002 (FR) 02 07658

(51) Int. Cl. G06F 15/16

(52) U.S. Cl. 709/227; 709/249

(57) ABSTRACT

The present invention relates to a process for managing context data (40) for a multilateral and multimode operation, using several software configurations allowing surfing on at least one network in order to access to a content provider service, representing information which is either specific to a content provision session via computer communication, through at least one information network (1), between at least one digital data processing device, called client terminal (30 to 35), and at least one content provider information system (2), or specific to the user of said client terminal(s), or specific to a combination of these elements, this context data (40) being stored outside the content provider information system(s) (2) and at the request of said provider system(s) (2), characterised in that it comprises at least one step wherein this context data is stored in storage means by one or more computer agents, called context proxies (4), in storage means independent of the client terminal(s) and of the software configuration concerned used, and accessible from at least one information or electronic system managing the information network (1).

The present invention relates to a process for managing client or session context information, linked to the provision of a service or content, through an information network like the Internet. This information may particularly be stored in the form of data known as “cookies”, stored outside the content provider's information system and at its request. These “cookies” may particularly be compatible with the Internet's HTTP protocol, or with modes of connection by mobile telephone that use a protocol such as Voice Gateway or VoiceXML or Wireless Application Protocol (WAP) or Short Message Service (SMS).

More and more entities are, using an information system to offer their services at a distance to numerous and varied clients, through one or more information networks such as the Internet for example. To the different participants in network and communications management, such an entity is also known as a content provider. Whatever the nature of this content, data consultation, purchase or sale of goods or services, data file transmission, it is often advantageous for the content provider to keep information about the context in which his service is provided to each client about his previous interactions with this provider or with others, or about his behavioural habits in using information networks.

For the content provider server, it is difficult or impossible to recognise the same user from one session to another, since his IP address is likely to change from one occasion to the other. In order to recognise each client more easily, and to prevent storing such context information relating to each client on the site server's information system, the software used to form a server providing content to a multiplicity of clients often has the capacity to send a certain amount of context data to the information system of each of these clients, data known for example as “cookies”. Moreover, within one and the same session with the same user and the same client terminal, the HTTP protocol does not either allow a context specific to this application session to be kept between two user requests. The same type of context data is then used in the form of “session cookies” often with a particularly short lifespan, for example 15 mn. This word “cookie”, which is of Anglo-Saxon origin, probably refers to the type of biscuits bearing same name, wherein some ingredients are incorporated in the form of small pieces.

A “cookie” is a short character string stored by an HTTP server in a file in the client's computer, or in a gateway used by the client. “Cookies” are used to preserve a context corresponding to the session, or to the client, between an HTTP server and a connected client. The mechanism often used consists in storing in the “cookie” a temporary identifier, often encrypted, which identifies the application session and is called a “session cookie”, or an identifier called a “client cookie” with a longer lifespan, for example one year, which identifies the client per se. Other permanent or temporary information contained in these “cookies” may be particularly the date and time the client accesses the provider site, a counter, a response to a questionnaire completed during this visit, personal information relating to the client and collected by the site's server or one of the servers participating in the communication, for example an IP address or a processor serial number identifying a machine. Counter use is a common application of the “cookie”. Each visit to a Web Page increases the value of a “cookie” linked to this page. By associating this counter with the visit date and time. It is possible to measure visit frequency and from this to deduce consultation habits.

These “cookies”, or context data, are stored in the client's information system, at the request of the provider's system and via the browser used by this client for consulting the content provider's site, for example a Web site using the Hyper Text Transfer Protocol (HTTP). This context data is stored without the user intervening in the client system, and is automatically retransmitted to the site of the same content provider or of another, during a subsequent consultation or connection. Such context data may be used for example to update a maximum expenditure authorised to a client in respect of one and the same retail site or one and the same retail site group, to present to the client advertising flags selected as a function of the sites he has previously visited, or to keep a tally of the number of different visitors hitting a given site by identifying each one of these visitors.

Such data may not however always allow the context accompanying each client to be recognised, particularly if he changes computer from one consultation to the next, for example by moving from a desktop computer to a laptop computer. Indeed even if he provides common information, such as the same identifying name, the same client user connecting through two different computers will not recognise common context data in a content provider system by relying solely on the system of “cookies” in accordance with the HTTP protocol.

One purpose of the invention is to allow a content provider information system of this type to recognise context data, for example session “cookies” or client “cookies”, corresponding to a given client user or to a given session, without having to manage its storage in the content provider's system and even when this client user uses several different information systems or several different software configurations to access the service of this provider.

Moreover, increasingly numerous services or contents are or will be accessible by means of networks or terminals that have the capacity to process digital or computing data, and that access the same content provider information system, but operate according to different standards or use different interfaces with the user.

The Internet site of one and the same content provider server may thus for example be accessible both by a conventional PC or Macintosh type micro-computer communicating with the Internet in HTTP using the TCP/IP protocol, and by a cellular telephone connecting to the Internet, but which is incapable of storing this type of context data. This connection may be made for example using the WAP protocol through a WAP Gateway using a UDP protocol when the WSP protocol battery is used, or TCP/IP for the WAP 2.0 protocol, or even by communicating via messages in character form transmitted in the SMS format. Such an Internet site may also be accessible from a wired or cellular telephone, using recognised voice commands in the form of commands codified in the voiceXML language and transmitted in TCP/IP or HTTP form to the content provider, via a gateway of the Voice Gateway type connecting the telephone network and the Internet.

Other types of terminals, for example personal organisers of the “Personal Digital Assistant” type (PDA) like the “Palm Pilot” (trademark), are or will be able to connect to the Internet network without being compatible with the context data storage requests used by a given content provider.

Likewise, certain types of terminal may communicate with one and the same content provider system according to a number of different modes, from one communication session or within one and the same session, for example using VoiceXML commands in respect of some interactions and using the WAP protocol or SMS messages in respect of other interactions.

Another purpose of the invention then is to allow such a content provider information system to recognise context data corresponding to a given client user, without having to manage its storage in the content provider's system and even when this client user uses several terminals, one at least of which is operating according to a mode that does not allow such context data to be stored within some of its terminals, or when this client user uses one or more terminals communicating with the content provider system according to at least one mode that does not allow such context data to be stored in a way that is compatible with the software used by the content provider system, or when this client user uses one or more terminals communicating with the content provider system according to a number of different modes that do not provide continuity in managing the context data associated with the session parts conducted in different modes.

One or more of these purposes are fulfilled by a process for managing context data, for a multilateral and multimode operation, using several software configurations allowing surfing on at least one network in order to access to a content provider service, representing information which is either specific to a content provision session via computer communication, through at least one information network, between at least one digital data processing device, called client terminal, and at least one content provider information system, or specific to the user of said client terminal(s), or specific to a combination of these elements, this context data being stored outside the content provider information system(s) and at the request of said provider system(s), characterised in that it comprises at least one step wherein this context data is stored in storage means by one or more computer agents, called context proxies, in storage means independent of the client terminal(s) and of the software configuration concerned used, and accessible from at least one information or electronic system managing the information network.

According to one feature, the process additionally comprises at least one operation of access by the client terminal according to a given software configuration to the content provider system by the sending of data representing an access request, this access operation including the following steps:

the receipt, by at least one context proxy, of data associated with a request for access to the content provider system from the client terminal according to the given software configuration, this data including at least a provider identification and a client identification;

the testing by the context proxy of the existence or non-existence of context data, stored in storage means independent of the client terminal, of the software configuration used and of the provider system, this context data corresponding to this provider identification and to this client identification;

the reading of this context data, and possibly the modification of this context data as a function of the information received corresponding to the access request;

the transmission, to the content provider system, of all or part of the read context data or of a version of the access request modified as a function of said context data.

According to one feature, the process comprises at least one operation of response by the content provider system to the client terminal by the sending of data representing a response, this response operation including the following steps:

the receipt, by at least one context proxy agent, of data associated with a response by the content provider system to the client terminal, this response including at least one request for storage of context data, this data having to be stored outside said content provider system and at its request;

the storage of context data, by the context proxy, in storage means independent of the client terminal and of the content provider system, this context data representing information associated with this response, or with the client terminal, or with the user of this client terminal, or with the content provider system.

According to one feature, the storage of the context data includes the storage of a client identifier or a session identifier.

According to one feature, the response operation from the content provider system to the client terminal additionally includes a step wherein the client terminal is asked for an authorisation to store context data.

According to one feature, the process includes at least one communication step where a context proxy agent communicates, directly or indirectly, on the one hand with the content provider system via the information network, and on the other hand with the client terminal or with a mode gateway allowing the information network to communicate with this client terminal according to a given communication mode different from the one used by the information network.

According to one feature, the process includes at least one communication step where a first context proxy agent communicates on the one hand with a first mode gateway allowing communication with this client terminal according to a first given communication mode, and on the other hand with a second context proxy agent communicating with said client terminal, this second context proxy agent communicating with this client terminal either via the information network or via a second mode gateway allowing communication between the network and this client terminal according to a second given communication mode.

According to one feature, the content provision session via computer communication includes a first session part, obtained by a communication according to the first communication mode, combined with a second session part, obtained via a communication according to the second communication mode, the process including at least one step of storage or reading context data representing information that can be used by the context proxy agent or by the content provider information system in order to associate these two session parts.

According to one feature, at least one communication step between the content provider information system and the context proxy agent is carried out by at least one protocol compatible with the TCP/IP protocol or the HTTP protocol.

According to one feature, the client terminal includes a digital terminal or a cellular telephone, at least one communication step between the client terminal and the network being carried out by wireless connection according to the GSM standard, or the DCS standard or the GPRS standard, or the Airport standard, or the Bluetooth standard or the ISO 802.11 standard (trademarks), or a variant or development of these standards.

According to one feature, the client terminal includes a digital terminal or a cellular or wired telephone, at least one communication step between the client terminal and the network being carried out by a protocol compatible with the WAP protocol, or a protocol using the VoiceXML language, or a variant or development of these protocols.

According to one feature, the network allows computer communication between the content provider system and the client terminal by using the Internet network or a network of the Intranet type.

According to one feature, the context data transmitted or the context data received by the content provider information system is organised in a format compatible with the “cookies” defined by the HTTP protocol.

To fulfil these objectives, the invention also proposes a system for managing context data, for a multiterminal and multimode operation, using several software configurations allowing surfing on at least one network in order to access to a content provider service, representing information, either specific to a content provision session via computer communication, through at least one information network, between at least one digital data processing device, called client terminal, and at least one content provider information system, or specific to the user of said client terminal, or specific to a combination of these elements, this context data being stored outside the content provider information system(s) and at the request of said provider system(s), characterised in that it includes at least one software agent, called context proxy, executed by calculation means and communicating with the information network, this context proxy storing this context data in storage means independent of the client terminal(s) and of the software configuration concerned.

According to one feature, the context proxy includes on the one hand means of reading and analysing data representing a response by the provider system to the client terminal within such a session and comprising context data which the provider system requests the client terminal to store, and on the other hand means of identifying this provider system, means of identifying this client terminal or the user of this client terminal, and means of storing all or part of this context data in association with the identification of this provider system, or of this client terminal, or of the user of this client terminal.

According to one feature, the context proxy includes means of reading and analysing data representing a request for access by the client terminal according to a given software configuration to the provider system within such a session, means of identifying this provider system, means of identifying this client terminal or the user of this client terminal, and means of completing or modifying this access request data as a function of context data previously stored by it and in keeping with this provider system and this client terminal or the user of this client terminal.

According to one feature, the means of completing or modifying the access request data allow a client identifier or a temporary identifier corresponding to the current session to be incorporated.

According to one feature, the system includes means for interposing the context proxy between the client terminal and the address or identification through which it seeks to enter into communication with the provider system, or means for redirecting the client terminal from this same address to an address leading to the context proxy, these interposition or redirecting means allowing the context proxy to receive in place and instead of the provider system all or part of the data sent by the client terminal to said content provider system.

According to one feature, the content provider system is accessible, from the information network, in the form of a standard “World Wide Web” site and communicates with the context proxy in accordance with the TCP/IP or HTTP protocol.

According to one feature, the information network includes one or more parts using the Internet network or an intranet network so as to allow computer communication between the context proxy, the client terminal, and the provider system, or between two of these elements.

According to one feature, the client terminal communicates with the information network through at least one information system, called mode gateway, providing transfer of computerised data between on the one hand the information network and on the other hand a second network allowing the transfer of digital data in a form that is not directly compatible with the information network or with the content provider system.

According to one feature, at least one mode gateway allows communication between on the one hand the information network and on the other hand a wired telephone network, or a GSM or DCS or GPRS cellular telephony network, or a communication network in accordance with the Bluetooth standard or the Airport standard or the ISO 802.11 standard (trademarks).

According to one feature, the system includes a plurality of context proxy agents communicating with each other, or with the content provider system, or both, through the information network, at least one of these context proxies being incorporated into a gateway providing conversion between several communication protocols or between several transmission modes.

The invention, with its characteristics and advantages, will emerge more clearly from reading the description given with reference to the appended drawings wherein:

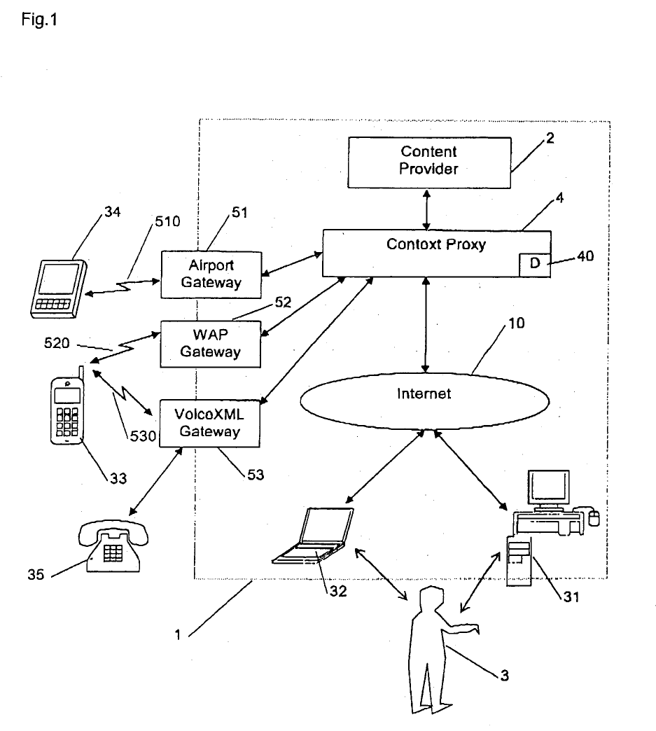

FIG. 1 shows a symbolic diagram of a system according to the invention using a process according to the invention, in an embodiment comprising an intermediate context proxy between the provider and several access networks or mode gateways;

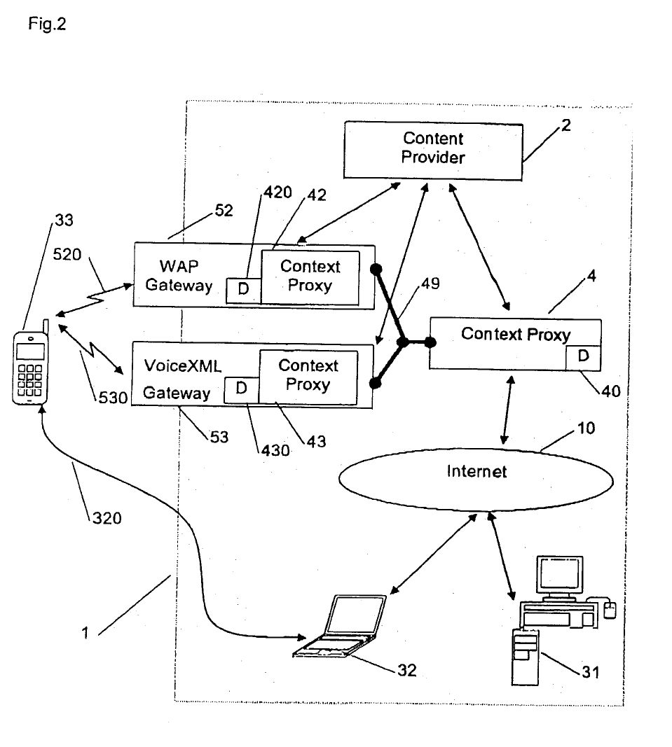

FIG. 2 shows a symbolic diagram of a system according to the invention using a process according to the invention, in an embodiment comprising several context proxies, some of which being integrated with a mode gateway;

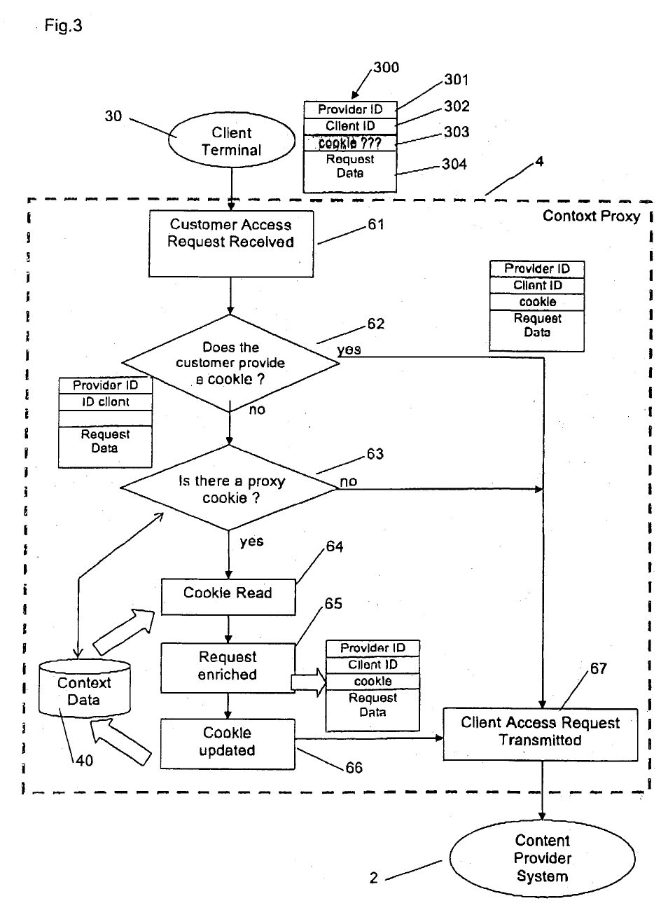

FIG. 3 shows a flow chart of one embodiment of the process according to the invention in the case where a client terminal transmits an access request to a content provider;

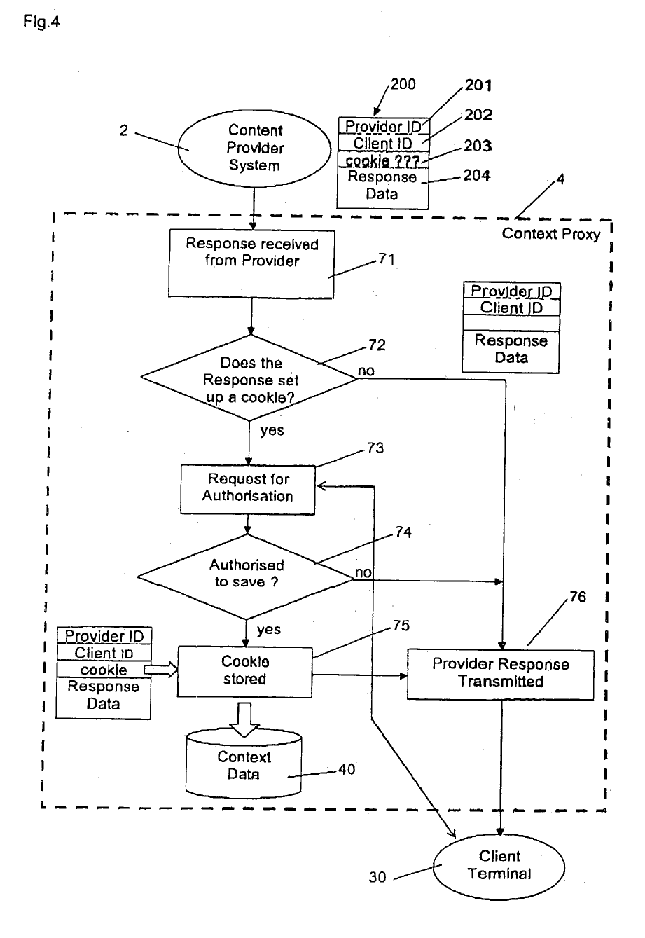

FIG. 4 shows a flow chart of one embodiment of the process according to the invention in the case where a content provider transmits a response to a client terminal.

Before commencing the description of the invention, it is necessary to clarify the following points.

The term software agent will be used for a software component that has the capacity to react to interactions with other software agents or with software or hardware events. It must be obvious that the mode of executing or storing a given software agent may vary within one or more information systems, so long as their organisation does not contradict the operation of the process herein described.

In an embodiment shown in FIGS. 1 and 2, a content provider entity or service provider uses a content provider information system (2) to propose access to a sizeable and variable number of users (3) using client terminals (31 to 35) via computer communication through an information network (1).

These client terminals may for example be computers (31, 32), fitted with browsers, compatible for example with the HTML or XML languages, and communicating with the Internet network (10) or a network of the intranet type, for example of the conventional type using TCP/IP and HTTP protocols to access web sites, in other words that may be consulted in accordance with the World Wide Web (www) standard.

Within the present description, the information network (1) will be treated as unique, but it is obvious that this network may include several different or variable architecture parts. Communication between two information systems in this network (1) may include the use of the Internet network on one or more parts of this network. Users may for example connect to the content provider's site (2) using the Internet network (10), possibly by means of a local network and/or a local gateway. Some functions herein described as coming under the client system, such as “cookies”, may then be carried out in this local network or in this gateway.

This information network (1) may also use the Internet network to communicate between the content provider system (2) and the context proxy (4), or between a gateway (51, 52, 53) and the context proxy (4) or the content provider system (2). Other types of connection may also be included in this network (1), such as specialised lines or X25 communications, so long as they allow communication between the different elements of this network (1) in accordance with the same protocols.

Commonly, one and the same user (3) may use alternately, or even at the same time, several different computers or several different pieces of software in order to connect to the site (2) of one and the same content provider. He may for example use on the one hand a desktop computer (31) and on the other hand a laptop or travel computer (32).

The process according to the invention includes the use of an intermediate software agent (4), called context proxy, which manages all or part of the context data relating to the user (3), or to the different sessions he conducts using the different information systems (31, 32). This context proxy agent (4) may play this part of intermediary in different ways depending on the applications of the invention. This part may be played for example by interposition between client system and provider system, by managing the “Universal Resource Locator” (URL) for accessing the provider system site (2). This part may also be played by a redirection from a system managing the URL address of the content provider's site. Furthermore, depending on the applications, the context proxy may have to manage and transmit all the data exchanged during a session between client and provider systems, or have to process only part of this data, and in particular the context data in full or in part.

This context proxy agent may of course be implemented in different regions of the information network (1) connecting the client terminals and the system or systems (2) used by the content provider. If several client terminals are used by a user by means of the Internet, this context proxy may for example be implemented on a server of the Internet access provider (IAP), using a service provider specialised in the site accommodation of content providers or providing services for such content providers, or directly in the content providers information system (2). In other variants not shown, the information system (1) in its entirety may also present other different if not heterogeneous configurations or topographies. It may also be composed in all or part of local (LAN), metropolitan (MAN) wide (WAN) networks, or incorporate one or more parts operating in the form of intranet type networks.

As shown in FIG. 1, the information network (1) may also allow access to the content provider system (2) from a client terminal (33, 34, 35) having a mode of operation which is not directly compatible with this content provider system (2) or with the network (1), as described below. This access is made possible by a network communication (1) with such a terminal through a system known as a mode gateway (51, 52, 53), the provider itself being connected to said network (1). This mode gateway then takes care of the protocol conversion that is necessary for interactions from the provider's point of view to take place in HTTP.

Such a mode gateway may communicate directly with the client terminal or communicate with another network allowing this communication, as shown in FIG. 2. Such gateways exist or will exist increasingly, and may for example be a WAP gateway (52) allowing communication between the information network (1) and a wired telephone (35), by communication through a Switched Telephone Network, or a cellular telephone (33) to the GSM or DCS standard by communication through a cellular telephony network. Such a mode gateway may also be a gateway (51) including an “Airport” type terminal allowing wireless communication (510) between a personal assistant (34) or a laptop computer (32) such as the Macintosh I-Book (trademark) and the Internet (10) or a local network. Gateways allowing communication from a laptop computer, or from a personal assistant, may also use terminals or local mini-networks to the “Bluetooth” standard or to the ISO 802.11 standard, for a peripheral device connected by cable (320), or by infrared, or by radio, this peripheral device being itself connected to a computer communicating with the network (1).

With the development in cellular telephone standards, particularly with the arrival of the GPRS and UMTS standards, such gateways may also make it possible to exchange commands or data in a form that is compatible with such a content provider system (2). A gateway between the network (1) and a cellular telephony network may particularly include software and hardware resources allowing it to interpret voice interactions in the form of software commands, or to restore voice type information from software information. The “voiceXML” language is an example of a language that can be used by such a gateway (53), called “Voice Gateway”, for communicating with the network (1), by sending computer commands similar to XML commands automatically from voice interactions received from a telephone.

In a variant not shown, within the network (1), such mode gateways may of course also communicate with the context proxy and the content provider system by means of the Internet network or a network of the Intranet type.

In a variant shown in FIG. 2, the functions of the context proxy are provided by several context proxy software agents (4, 42, 43), distributed in the network (1), and some of which (42, 43) may be associated or incorporated with mode gateways (52 and 53 respectively). One or more gateways then provide, in addition to the conversion of protocols, the function of storage and retransmission of the “cookies”.

In an option of this variant, these context proxies (4, 42, 43) distributed in the network (1) may also be provided so as to comprise means (49) of communicating with each other via the network (1), thus allowing a pooling of their context data, or session “cookies”, which may be transparent in respect of the content provider (2).

In the embodiment shown in FIG. 1, communications between the client terminal and the content provider system (2), pass through the context proxy agent (4). This transit is obtained for example by making the URL address corresponding to the content provider system (2) and to the web site it manages lead to the context proxy (4). This URL address may also lead to the provider system (2), the latter then redirecting client terminal access requests to a URL address leading to the context proxy.

As shown in FIG. 3, a request (300) for HTTP access to the content provider system (2) from the client terminal (30) is received (61) by the context proxy (4). This request includes request data (304) associated with one or more headers containing data representing different additional information. This information is in particular an identification (301) of the provider to whom the access request is addressed, an identification (302) of the client, and any context data or a “cookie” (303) stored during a previous session or session part by the client terminal (30).

Depending on the applications, the provider identification (301) may comprise the IP or URL address for accessing the provider system (2). Depending on the embodiments and depending on the access modes, the identification (302) of the client terminal (30) may take different forms, and be more on less accurate or permanent. It may be an IP address identifying the client terminal within the TCP/IP network and transmitted by the client's Internet access provider or by an intermediate gateway. It may be a name entered by the user to access an account or service, or a subscription, terminal, security key, chip card, or software serial number. It may be a calling party number coming from a wired or cellular telephone network, for example an MSISDN number or identifier transmitted by means of an element of the telephone network or a mode gateway (51, 52, 53).

The context proxy (4) includes or uses means (40, 402, 403) for detecting this client identification (302), provided so as to detect or receive one or more of these identifiers and possibly to combine them with each other so as to obtain said client identification (302).

On receipt of this access request, the context proxy carries out a step (62) wherein the information contained in or associated with this request is tested, to find out whether the client terminal is providing a “cookie” (303), in other words context data that is usable by this provider or is in keeping with this provider. This step includes a test of the client identification (302) and/or the provider identification (301).

If the access request does not comprise any context data, or comprises data not corresponding to given parameters, the context proxy carries out a step (63) wherein the provider identification (301) and the identification (302) of this access request (300) are tested. By comparing these identifications (301, 302) and the different context data (40) to which it has access, the context proxy (4) then determines whether it already has, for this client terminal (30) or for the user (3) of this client terminal, context data that may be used by this provider (2) or is in keeping with this provider.

If such context data (40) is present, it is read during a step (64) by the context proxy, which uses it to enrich the content of the access request (300) received from the client terminal (30). Depending on the applications, this enrichment may occur by adding the data read at the access request, or by modifying all or part of this request as a function of this same context data. In the embodiment herein described, this enrichment includes particularly the insertion of this context data (40) into the header of the access request (300), as if it was a “cookie” (303) received directly from the client terminal (30). In a variant (not shown) applied to the dynamic URL mechanism cited below, this enrichment may include the modification of the address requested, by adding to it provider identification data (301) or the terminal or client identification data (302), from this context data (40) recognised by the context proxy.

Depending on the applications, the context proxy may also modify, during a step (66), the stored context data (40), for example in order to record therein the date of this access request or to update the lifespan stored for this “cookie”.

The context proxy will then transmit the access request (300) to the content provider system (2), enriched from context data (40) provided by it where necessary.

If the client terminal (30) connects to the provider system (10) without a “cookie” when its user has already consulted this same provider from another terminal during a previous session, it is then possible for the content provider to have cognisance of this previous connection by context data provided by the context proxy, so long as some client identification data (302) is common to these two sessions. It is therefore possible for the content provider to recognise this user, with all the advantages this is known to have, particularly in the commercial or statistical field.

As shown in FIG. 3, a response (200) from the content provider system (2) to the client terminal (30) is received (71) by the context proxy (4) during a communication session. This response includes response data (204) associated with one or more headers containing data representing different additional information. This information is in particular an identification (201) of the provider issuing the response, an identification (202) of the client to whom the response is addressed, and any context data or “cookie” (203) the provider system (2) wishes to have stored, or to set up, in relation to this session or the user (30) of this client terminal (30).

Depending on the applications, the provider identification (201) may include the IP or URL address of the provider system (10), or a subscription identifier for this provider or for a group of different providers able to be involved by this response or this session or the cookies which they set up.

Depending on the embodiments and depending on the access modes, the identification (202) of the client terminal (30) may take different forms, and be more or less accurate or permanent. It may be an IP address identifying the client terminal within the TCP/IP network and transmitted by the client's Internet access provider or by an intermediate gateway. It may be a name entered by the user to access an account or service, or a subscription, terminal, security key, chip card, or software serial number. It may be a calling party number coming from a wired or cellular telephone network, for example an MSISDN number or an identifier transmitted by means of an element of the telephone network or a mode gateway (51, 52, 53).

The context proxy (4) will then carry out a step (72) wherein the information contained in or associated with this response is tested, to find out whether this response requests the storage, or the setting up of a “cookie” (203) in the client terminal (30), particularly in accordance with the “cookie” standard used in WWW and HTTP protocols.

If this response comprises a “cookie” storage request (203), the context proxy will then carry out a step of storage (75) of this “cookie” (203), in the form of context data (40), in storage means independent of the client terminal (30), for example in storage means of the information system which executes this context proxy agent (4). Thus, whatever the future of the terminal (30) used by the client accessing the content provider, the context data (203) sent by the provider system (2) will be retained or recognised during a subsequent access request (300) such as described above.

According to an option allowing the user of the client terminal to be left in control of the information stored thereon, the context proxy carries out a step (73) wherein the client terminal (30) is asked if it is programmed to authorise context data storage, in a general way or in the present case. This authorisation request step (73) may be carried out for example by the same channel used for exchanging requests and responses with this client terminal. As a function of the response by the client terminal (30), the context proxy (4) will then carry out or not carry out a step (75) wherein the “cookie” (203) requested by the provider is stored, in the form of context data (404) stored in storage means independent of the client terminal (30) and of the provider system (2).

The context proxy will then transmit to the client terminal (30) the data representing the response (200) of the content provider system (2).

Compared with the known process of storing “cookies” in the client terminal, it is thus possible to store context data in a transparent way for the content provider (2), even if the client terminal (30) is of a type that is not compatible with the conventional process or of a type that does not allow data storage.

In the event of the content provider system (2) being accessed by a client terminal having several modes (520, 530, 320) of communication with the network (1), the process according to the invention also makes it possible to store, then to combine together context data, or session “cookies”, stored for each of these different modes (520, 530, 320). If one and the same communication session between the client user and the content provider system (2) includes the alternate or simultaneous use of several modes of communication in several session parts, with one and the same client terminal (33), or with several client terminals (33, 32, 31), the process according to the invention then makes it possible to combine these different session parts, so as to reconstitute the unity of a multi-modal session for example.

One example of a multi-modal session may be the access to a service, on the content provider's site, using a portable cellular telephone (33), both via accesses in accordance with the WAP mode and by accesses in accordance with the VoiceXML mode. During a session part where a user (3) browses in the service using his telephone in accordance with the WAP access mode through the WAP gateway (10), the provider system (2) transmits a “cookie” which the context proxy (4) stores “as it passes” in its storage means. After a number of actions in the service, the content provider offers the user the chance to continue his browsing using a voice interface, in a VoiceXML type mode. To do this, the service offers the user for example a WAP type command entitled “WTA”, which will trigger calling the VoiceXML gateway (53).

When the VoiceXML gateway transmits an HTTP request to the content provider system (2), this request passes through the context proxy (4). By comparing the client identifiers received by its detection means (40) from the WAP then VoiceXML gateways, with data already stored, for example in a previous session “cookie”, the context proxy notes that these identifiers correspond to one and the same telephone (33) and are addressed to the same provider. It will then enrich the request coming from the VoiceXML gateway with the session “cookie” that it had previously stored during the WAP part of the session. The VoiceXML type request may then be processed by the provider system with the benefit of the session context generated during the previous WAP access.

When the user terminates his voice access, the WAP access may restart, when the telephone detects a WAP type event entitled “WTA call end” or when the user validates a corresponding link or button on the previously displayed WAP page.

In the same way, when the session returns to WAP mode, the context proxy performs the combination with the voice session part, by identifying the user and by recognising the session “cookie” previously stored during a VoiceXML request. The rest of the session then benefits from the context stored and kept updated both during the first WAP session part and during the VoiceXML session part. The process thus allows application context continuity to be maintained within a session using these two access types.

Such multi-modal sessions may thus be reunified, for example for more accurate or more certain processing, in varied applications. It may for example be a question of using a cellular telephone to carry out a number of interactions that are too complex for a telephone keypad, for example indicating a destination to a route manager system, these interactions then passing through a voice gateway (53). Since the information within one and the same multi-modal session has to be permanent. It may then be transmitted via a WAP gateway or by SMS messages, for example so as to display a journey plan on the telephone or personal assistant screen.

Within the network (1), all of the context data obtained by the process according to the invention may be managed at different levels. One or more context proxies may for example manage the association of context data coming from different session parts so as to restore the unity of the multi-modal session, in a transparent way for the content provider system (2).

One or more context proxies may also enrich this context data by combining it with various information coming from some management elements of the information network (1) per se, such as a router or a server, for example a Radius server (trademark). Such information may for example be an IP address used by the TCP/IP protocol to identify a node within the network (1), or a number identifying the cellular telephone or the SIM card that it uses, transmitted for example by the mode gateway.

The process thus allows the totality of a multi-modal session to be restored to the provider, as if it was a straightforward single session.

The process according to the invention thus allows the storage of “cookies” or the reading of these “cookies”. In a transparent way in respect of a Web server then constituting the provider system (2), particularly in the case of access from a portable telephone (33) or a wired telephone (35) or from a personal assistant (34), from several different computers (31, 32) or from a combination of such devices.

In other variants (not shown), a content provider system uses a mechanism of addresses calculated as a function of the context of each session, also called “dynamic URLs” (from Universal Resource Location”). This mechanism includes, inter alia, the fact of associating identification data with some of the addresses communicated to the client terminal to guide it during a session as browsing links within the content provider's web site.

By choosing to follow a link the address of which has been communicated to it by the provider system, the client terminal then transmits an access request containing data previously calculated by the provider as a function of the context of this user or of his terminal. This data may then be tested and stored by the process according to the invention, in the form of context data (40), in the same way as the “cookies” described above.

It must be obvious for those skilled in the art that the present invention allows embodiments in many other specific forms without departing from the field of application of the invention as claimed. Consequently, the present embodiments must be considered as examples, but may be modified in the field defined by the scope of the appended claims, and the invention is not to be restricted to the details given above.

What is claimed is:

1. Process for managing context data, for a multilateral and muitimode operation, using several software configurations allowing surfing on at least one network in order to access to a content provider service, representing information which is either specific to a content provision session via computer communication, through at least one information network, between at least one digital data processing device, called client terminal, and at least one content provider information system, or specific to the user of said client terminal(s), or specific to a combination of these elements, this context data being stored outside the content provider information system(s) and at the request of said provider system(s), characterised in that it comprises at least one step wherein this context data is stored in storage means by one or more computer agents, called context proxies, in storage means independent of the client terminal(s) and of the software configuration concerned used, and accessible from at least one information or electronic system managing the information network.

2. Process according to claim 1, characterised in that it additionally comprises at least one operation of access by the client terminal according to a given software configuration to the content provider system by the sending of data representing an access request, this access operation including the following steps:
the receipt by at least one context proxy, of data associated with a request for access to the content provider system from the client terminal according to the given software configuration, this data including at least a provider identification and a client identification;
the testing by the context proxy of the existence or non-existence of context data, stored in storage means independent of the client terminal, of the software configuration used and of the provider system, this context data corresponding to this provider identification and to this client identification;
the reading of this context data, and possibly the modification of this context data as a function of the information received corresponding to the access request;
the transmission to the content provider system, of all or part of the read context data or of a version of the access request modified as a function of said context data.

3. Process according to claim 1, characterised in that it comprises at least one operation of response by the content provider system to the client terminal by the sending of data representing a response, this response operation including the following steps:
the receipt, by at least one context proxy agent, of data associated with a response by the content provider system to the client terminal, this response including at least one request for storage of context data, this data having to be stored outside said content provider system and at its request;
the storage of context data, by the context proxy, in storage means independent of the client terminal and of the content provider system, this context data representing information associated with this response, or with the client terminal, or with the user of this client terminal, or with the content provider system.

4. Process according to claim 3, characterised in that the storage of the context data includes the storage of a client identifier or a session identifier.

5. Process according to claim 3, characterised in that the response operation from the content provider system to the client terminal additionally includes a step wherein the client terminal is asked for an authorisation to store context data.

6. Process according to claim 1, characterised in that it includes at least one communication step where a context proxy agent communicates, directly or indirectly, on the one hand with the content provider system via the information network, and on the other hand with the client terminal or with a mode gateway allowing the information network to communicate with this client terminal according to a given communication mode different from the one used by the information network.

7. Process according to claim 1, characterised in that it includes at least one communication step where a first context proxy agent communicates on the one hand with a first mode gateway allowing communication with this client terminal according to a first given communication mode, and on the other hand with a second context proxy agent communicating with said client terminal, this second context proxy agent communicating with this client terminal either via the information network or via a second mode gateway allowing communication between the network and this client terminal according to a second given communication mode.

8. Process according to claim 7, characterised in that the content provision session via computer communication includes a first session part, obtained by a communication according to the first communication mode, combined with a second session part, obtained via a communication according to the second communication mode, the process including at least one step of storage or reading context data representing information that can be used by the context proxy agent or by the content provider information system in order to associate these two session parts.

9. Process according to claim 1, characterised in that at least one communication step between the content provider information system and the context proxy agent is carried out by at least one protocol compatible with the TCP/IP protocol or the HTTP protocol.

10. Process according to claim 1, characterised in that the client terminal includes a digital terminal or a cellular telephone, at least one communication step between the client terminal and the network being carried out by wireless connection according to the GSM standard, or the DCS standard or the GPRS standard, or the Airport standard, or the Bluetooth standard or the ISO 802.11 standard (trademarks), or a variant or development of these standards.

11. Process according to claim 1, characterised in that the client terminal includes a digital terminal or a cellular or wired telephone, at least one communication step between the client terminal and the network being carried out by a protocol compatible with the,WAP protocol, or a protocol using the VoiceXML language, or a variant or development of these protocols.

12. Process according to claim 1, characterised in that the network allows computer communication between the content provider system and the client terminal by using the Internet network or a network of the Intranet type.

13. Process according to claim 1, characterised in that the context data transmitted or the context data received by the content provider information system is organised in a format compatible with the “cookies” defined by the HTTP protocol.

14. System for managing context data, for a multiterminal and multimode operation, using several software configurations allowing surfing on at least one network in order to access to a content provider service, representing information, either specific to a content provision session via computer communication, through at least one information network, between at least one digital data processing device, called client terminal, and at least one content provider information system, or specific to the user of said client terminal(s), or specific to a combination of these elements, this context data being stored outside the content provider information system(s) and at the request of said provider system(s), characterised in that it includes at least one software agent, called context proxy, executed by calculation means and communicating with the information network, this context proxy storing this context data in storage means independent of the client terminal(s) and of the software configuration concerned.

15. System according to claim 14, characterised in that the context proxy includes on the one hand means of reading and analysing data representing a response by the provider system to the client terminal within such a session and comprising context data which the provider system requests the client terminal to store, and on the other hand means of identifying this provider system, means of identifying this client terminal or the user of this client terminal, and means of storing all or part of this context data in association with the identification of this provider system, or of this client terminal, or of the user of this client terminal.

16. System according to claim 14, characterised in that the context proxy includes means of reading and analysing data representing a request for access by the client terminal according to a given software configuration to the provider system within such a session, means of identifying this provider system, means of identifying this client terminal or the user of this client terminal, and means of completing or modifying this access request data as a function of context data previously stored by it and in keeping with this provider system and this client terminal or the user of this client terminal.

17. System according to claim 14, characterised in that the means of completing or modifying the access request data allow a client identifier or a temporary identifier corresponding to the current session to be incorporated.

18. System according to claim 14, characterised in that it includes means for interposing the context proxy between the client terminal and the address or identification through which it seeks to enter into communication with the provider system, or means for redirecting the client terminal from this same address to an address leading to the context proxy, these interposition or redirecting means allowing the context proxy to receive in place and instead of the provider system all or part of the data sent by the client terminal to said content provider system.

19. System according to claim 14, characterised in that the content provider system is accessible, from the information network, in the form of a standard “World Wide Web” site and communicates with the context proxy in accordance with the TCP/IP or HTTP protocol.

20. System according to claim 14, characterised in that the information network includes one or more parts using the Internet network or an intranet network so as to allow computer communication between the context proxy, the client terminal, and the provider system,, or between two of these elements.

21. System according to claim 14, characterised in that the client terminal communicates with the information network through at least one information system, called mode gateway, providing transfer of computerised data between on the one hand the information network and on the other hand a second network allowing the transfer of digital data in a form that is not directly compatible with the information network or with the content provider system.

22. System according to claim 14, characterised in that at least one mode gateway allows communication between on the one hand the information network and on the other hand a wired telephone network, or a GSM or DCS or GPRS cellular telephony network, or a communication network in accordance with the Bluetooth standard or the Airport standard or the ISO 802.11 standard (trademarks).

23. System according to claim 14, characterised in that it includes a plurality of context proxy agents communicating with each other, or with the content provider system, or both, through the information network, at least one of these context proxies being incorporated into a gateway providing conversion between several communication protocols or between several transmission modes.
